(19) United States
(12) Patent Application Publication
(10) Pub. No.: US 2026/0268344 A1
(43) Pub. Date: Sep. 10, 2026

(54) SYSTEM AND METHOD FOR IDENTIFYING COUNTERFEIT PRODUCTS USING LIVE VERIFICATION WITH UNIQUE, PRIVACY-PRESERVING, UNPREDICTABLE, AND TAMPERPROOF QR CODES INTEGRATED WITH BLOCKCHAIN

(71) Applicant: Ali Asghar SAFRI, Dubai (AE)

(72) Inventor: Ali Asghar SAFRI, Dubai (AE)

(21) Appl. No.: 19/073,076

(22) Filed: Mar. 7, 2025

(51) Int. Cl. G06Q 30/018

(52) U.S. Cl. CPC G06Q 30/0185

(57) ABSTRACT

The present disclosure relates to a system and method for counterfeit product identification and authentication using blockchain-integrated QR codes. The system generates unique, privacy-preserving, tamperproof, and unpredictable QR codes, which are cryptographically secured and linked to a blockchain smart contract for immutable tracking. The authentication and tracking system enables real-time product verification by manufacturers, intermediaries, retailers, and consumers, ensuring secure interactions within a predefined workflow. The system prevents unauthorized duplication through AES-256 encryption and SHA-512 hashing, ensuring counterfeit detection. Consumers can verify product authenticity through quick and detailed verification, including geolocation-based validation. Ownership transfers and secondary market transactions are securely recorded on the blockchain, maintaining verifiable provenance. The system further facilitates counterfeit reporting by allowing users to submit evidence. By integrating blockchain technology, cryptographic security, and privacy-preserving verification mechanisms, the system ensures robust counterfeit prevention, enhances supply chain transparency, and fosters consumer trust.

### FIELD

The present disclosure relates to the field of product authentication and anti-counterfeiting technologies. More particularly, it pertains to a system and method for identifying counterfeit products and tracking product authenticity across the supply chain using live verification with unique, privacy-preserving, unpredictable, and tamperproof QR codes integrated with blockchain technology.

### BACKGROUND AND PRIOR ART

Counterfeiting of products has become a significant global issue, affecting industries such as pharmaceuticals, electronics, luxury goods, and consumer products. The proliferation of counterfeit goods not only causes substantial economic losses for manufacturers but also poses serious risks to consumer safety and brand integrity. Traditional anti-counterfeiting measures, such as holograms, barcodes, and serial numbers, are increasingly vulnerable to replication and manipulation by counterfeiters. These conventional methods often lack real-time verification capabilities and fail to provide robust traceability throughout the supply chain.

Existing QR code-based solutions, while commonly used for product tracking and authentication, suffer from inherent vulnerabilities. QR codes can be easily duplicated, and without proper encryption or security mechanisms, they fail to prevent unauthorized copying or tampering. Moreover, many current systems do not offer privacy-preserving features, making sensitive product information susceptible to exposure during verification processes.

Additionally, supply chain complexity further exacerbates the challenge of maintaining product authenticity. As products move through multiple intermediaries, the lack of transparent and tamper-proof tracking mechanisms increases the risk of counterfeit products infiltrating the supply chain. Centralized databases used for tracking are prone to data breaches, unauthorized access, and manipulation, undermining the reliability of authenticity verification.

While blockchain technology has been explored for its potential to provide tamper-proof records, existing implementations often face limitations related to scalability, privacy concerns, and integration complexities with physical product tracking systems.

Therefore, there is a need for an advanced system and method that can address these limitations by ensuring real-time, secure, and privacy-preserving product authentication. Such a system should prevent counterfeiting, detect duplicate products, maintain tamper-proof records, and enable seamless verification across the supply chain. The present disclosure aims to fulfil these requirements through the integration of live verification with unique, unpredictable, and tamperproof QR codes integrated with blockchain-based tracking and authentication mechanisms.

### Objects

Some of the objects of the present disclosure are described herein below:

A primary object of the present disclosure is to provide a system and method for identifying counterfeit products using live verification with unique, privacy-preserving, unpredictable, and tamperproof QR codes integrated with blockchain technology.

Another object of the present disclosure is to ensure the generation of unique and non-replicable QR codes for each individual product, thereby preventing unauthorized duplication and counterfeit attempts.

Yet another object of the present disclosure is to enable real-time verification of product authenticity through quick and detailed verification mechanisms accessible via software applications or authorized APIs.

Still another object of the present disclosure is to ensure maintain tamper-proof records of product data and ownership by leveraging blockchain's immutable ledger capabilities, ensuring data integrity across the supply chain.

Another object of the present disclosure is to facilitate secure ownership transfer of products within the supply chain and in secondary market transactions, while preserving data privacy and authenticity verification.

Yet another object of the present disclosure is to prevent counterfeit products from infiltrating the supply chain by restricting QR code generation and product data updates to authorized manufacturers and verified partners.

Another object of the present disclosure is to provide a privacy-preserving verification process that allows product authentication without exposing sensitive supply chain or ownership information to unauthorized parties.

Still another object of the present disclosure is to detect and report counterfeit activities effectively, enabling consumers and stakeholders to submit evidence and alerts to manufacturers for swift investigation and action.

Another object of the present disclosure is to support interoperability with multiple blockchain platforms, including both public and private blockchains, enhancing flexibility and scalability for different industries.

Another object of the present disclosure is to enhance consumer trust and brand protection by providing a transparent, secure, and easy-to-use product authentication system.

Still another object of the present disclosure is to enable consumers to report counterfeit activities, allowing manufacturers to identify and blacklist counterfeit sources while mapping counterfeit locations for enhanced brand protection.

Another object of the present disclosure is to provide a consumer wallet that stores product authentication records from multiple manufacturers, enabling easy access and verification of purchased products in one place.

The other objects and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, embodiments herein provides a system and method for identifying counterfeit products using blockchain technology and ensuring secure product tracking across the supply chain. The system includes an authentication and tracking system configured to authenticate, track, and detect counterfeit products by collecting and updating product tag data at various stages of the supply chain.

The present disclosure provides a system and method for identifying counterfeit products and ensuring secure product authentication using blockchain-integrated QR codes. The system employs an authentication and tracking system designed to generate unique, privacy-preserving, tamperproof, and unpredictable QR codes for individual products. These QR codes are cryptographically secured and linked to a blockchain smart contract, ensuring immutable tracking of product authenticity throughout the supply chain.

The authentication and tracking system enables real-time product verification and facilitates secure interactions between multiple stakeholders, including manufacturers, intermediaries, retailers, and consumers. Each stakeholder is assigned specific roles within a predefined workflow, ensuring controlled access and compliance with manufacturer-defined security protocols. The system records key supply chain events, such as manufacturing, warehousing, retail distribution, and consumer purchases, ensuring the integrity of product movement and preventing unauthorized modifications.

The system is designed to prevent counterfeiting by enforcing strict controls on QR code generation, verification access, and data updates, restricting these activities to verified manufacturers and authorized supply chain partners. Each QR code is uniquely generated and encrypted using a unique AES-256 encryption for each manufacturer and undergoes periodic key rotation to enhance security and minimize cryptographic vulnerabilities. The system also employs SHA-512 hashing for added security and uniqueness, ensuring that QR codes cannot be duplicated, tampered with, or predicted by counterfeiters.

During product authentication, consumers can scan the QR code using a consumer device, triggering a two-step verification process. Quick verification checks the product state by cross-referencing the QR code identifier against the blockchain record to determine its authenticity and supply chain status. Detailed verification retrieves additional metadata for the retailer and its location allowing further scrutiny of suspicious or potentially counterfeit items.

To further enhance counterfeit detection, the system integrates geolocation-based verification, wherein the consumer's location is cross-checked with the registered retailer's location. If any discrepancy is detected, the system generates an automated counterfeit alert and allows consumers to submit evidence, such as photos, videos, or location data, to aid manufacturers in investigating counterfeit activities.

Additionally, the authentication and tracking system supports secure ownership transfers, enabling consumers to resell authenticated products within a regulated secondary market. Ownership transfer transactions are recorded immutably on the blockchain smart contract, ensuring verifiable provenance tracking and preventing unauthorized resale or fraudulent modifications. The system also maintains privacy safeguards, ensuring that ownership and supply chain data remain accessible only to authorized stakeholders while protecting sensitive business and consumer information.

By integrating blockchain technology, cryptographically secured QR codes, and privacy-preserving verification mechanisms, the present disclosure provides a robust, scalable, and efficient solution for counterfeit prevention, supply chain transparency, and consumer trust enhancement.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items

FIG. 1 illustrates an exemplary architecture of the authentication and tracking system that facilitates product authenticity verification by integrating cryptographically secured, privacy-preserving QR codes with a blockchain smart contract, according to an embodiment of the present disclosure;

FIG. 2 illustrates an exemplary architecture of the authentication and tracking system, according to an embodiment of the present disclosure;

FIG. 3 illustrates an exemplary flow diagram of the system and method for generating a unique QR code imprinted on a product, according to an embodiment of the present disclosure;

FIG. 4 illustrates an exemplary flow diagram of the system and method for supply chain tracking and status recording, according to an embodiment of the present disclosure;

FIG. 5 illustrates an exemplary flow diagram of the system and method for quick and detailed verification of a product's authenticity and reporting counterfeit, according to an embodiment of the present disclosure; and

FIG. 6 illustrates an exemplary system architecture for ownership transfer and secondary market transactions performed by the consumer, according to an embodiment of the present disclosure.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

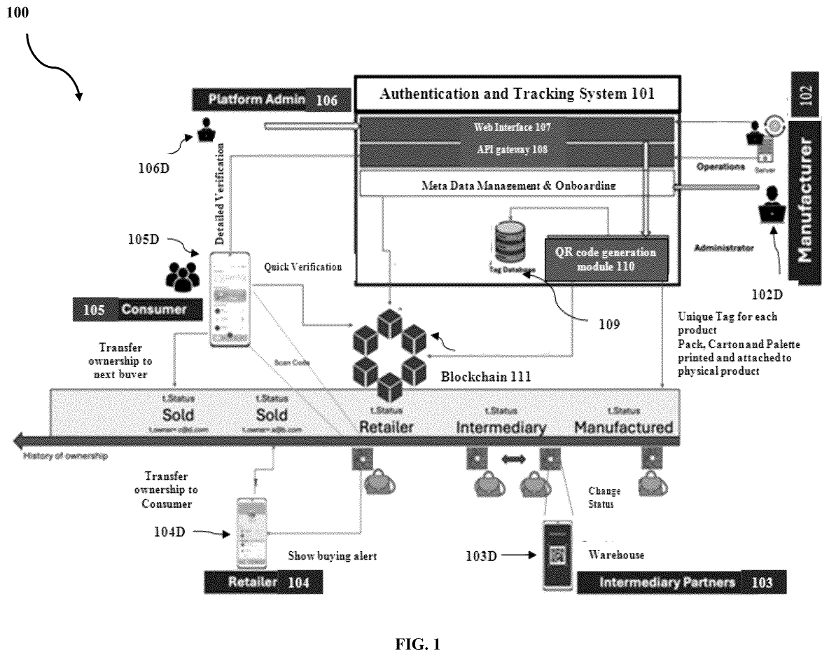

As mentioned above, there is a need to generate unique QR codes linked to a blockchain smart contract to ensure real-time, secure, and privacy-preserving product authentication. Specifically, a transparent and tamper-proof system is required to identify counterfeit products, detect duplicates, and maintain immutable records using blockchain technology. The present disclosure addresses this requirement by providing a system and method for counterfeit detection, product authentication, and supply chain tracking using blockchain-integrated QR codes. Referring now to the drawings, FIGS. 1 through 6 illustrate preferred embodiments, where similar reference numerals consistently denote corresponding features across the figures.

In an embodiment, FIG. 1 illustrates an exemplary architecture (100) of the authentication and tracking system (101) that facilitates product authenticity verification by integrating cryptographically secured, privacy-preserving QR codes [hereinafter referred to as unique QR codes] with a blockchain (111) smart contract. The authentication and tracking system (101) ensures counterfeit prevention by leveraging blockchain-based immutable tracking and verification, which will be further elaborated in subsequent sections.

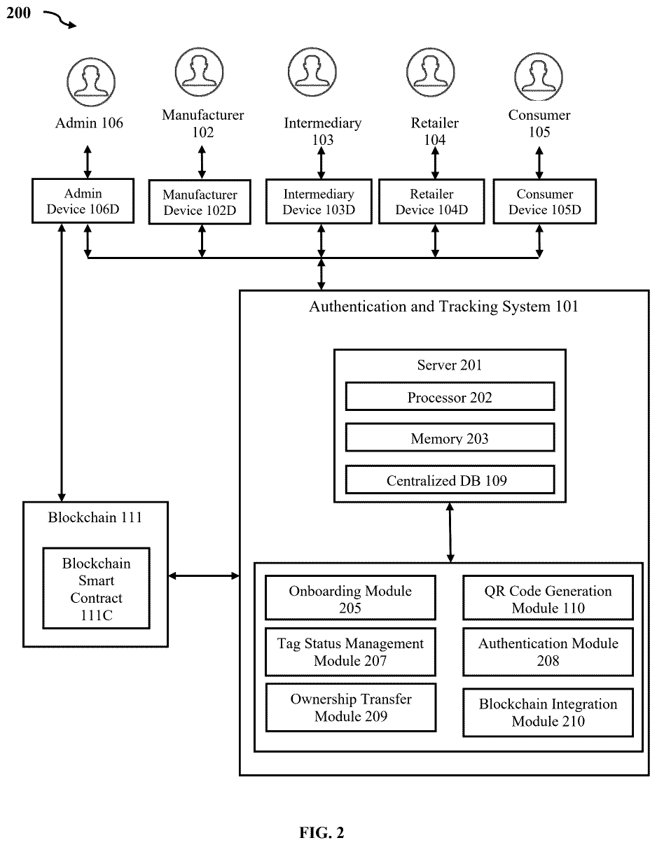

In an embodiment, the authentication and tracking system (101) can comprise multiple components and modules that facilitate authentication, tracking, and ownership verification. The functionality of the components and modules will be further detailed in FIG. 2. A blockchain (111) can store an immutable product tracking ledger, including essential tracking details such as manufacturer codes, product codes, product state, and tag identifier (t). Meanwhile, ownership transitions at intermediary levels (e.g., warehouses, stockists) are initially recorded in the centralized DB (109) and later updated on the blockchain (111) only for predefined state changes such as ‘Manufactured’ ‘Custom Intermediary State’ ‘Retailer’ and ‘Sold’. A blockchain (111) smart contract facilitates automated product verification and ownership transfers based on predefined rules.

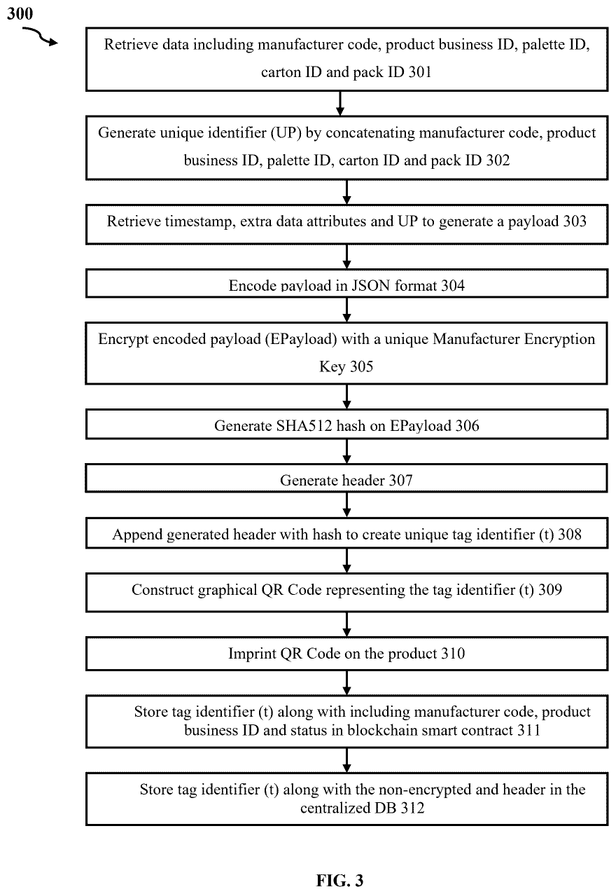

The authentication and tracking system (101) can further include an admin device (106D) operated by a platform admin (106) for onboarding manufacturers (102) and managing access controls, a web interface (107) for registry management, an API gateway (108) for integration, a centralized database [DB] (109) for secure storage, and a QR code generation module (110) for generating unique QR codes. Each QR code is securely generated using AES-256 encryption with a version-controlled private key assigned to each manufacturer. The encryption key undergoes monthly rotation, ensuring enhanced security and preventing cryptographic attacks. The QR code generation method will be detailed in FIG. 3.

In an embodiment, the authentication and tracking system (101) can enable different stakeholders, including manufacturers (102), intermediary partners (103), retailers (104), consumers (105), and the platform admin (106), to securely interact based on their assigned roles. The platform admin (106) can verify manufacturer credentials, set up registries, and enforce compliance through a web app. Manufacturers (102) can use a manufacturer device (102D) to define product templates, assign roles, configure workflows, and manage supply chain partners. Additionally, the manufacturer device (102D) can enable the generation of unique QR codes through the QR code generation module (110), wherein the unique QR codes are imprinted on the products.

The generated unique QR codes, along with tag status updates at different levels such as palette, carton, or pack, are securely stored in the centralized DB (109) and synchronized with the blockchain (111) based on predefined rules for supply chain verification. Immutable state transitions-including ‘Manufactured,’ ‘Custom Intermediary State’, ‘Retailer,’ and ‘Sold’ are stored on the blockchain (111).

In an embodiment, intermediary partners (103), including warehouses and stockists, can use an intermediary device (103D) to scan product tags and update tag statuses as the product moves through the supply chain. The intermediary device (103D) can interact with the authentication and tracking system (101) to synchronize product movement records with the centralized DB (109) and verify supply chain integrity.

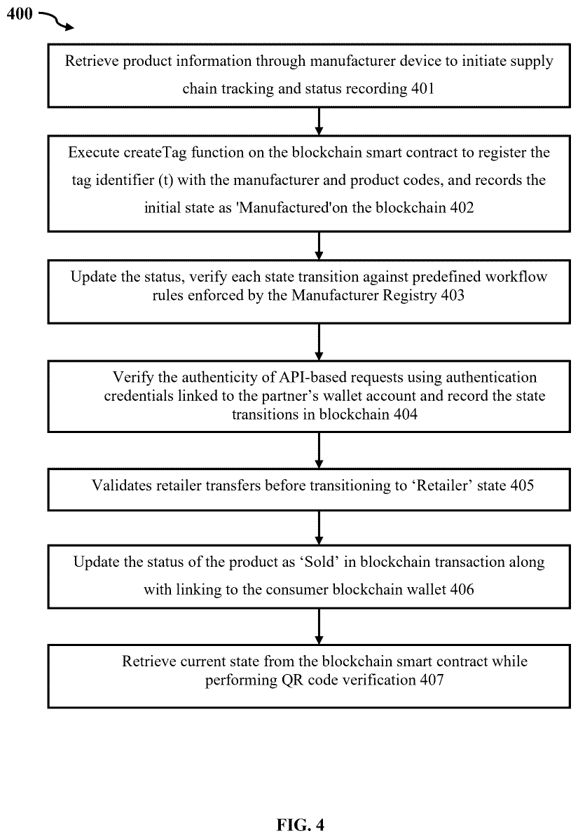

In an embodiment, retailers (104) can use a retailer device (104D) to verify the authenticity of products before sale and transfer ownership upon purchase. The retailer device (104D) can interact with the authentication and tracking system (101) to confirm legitimacy, update product state, and facilitate ownership transfer to the consumer. The mechanism of supply chain tracking and status recording will be further detailed in FIG. 4.

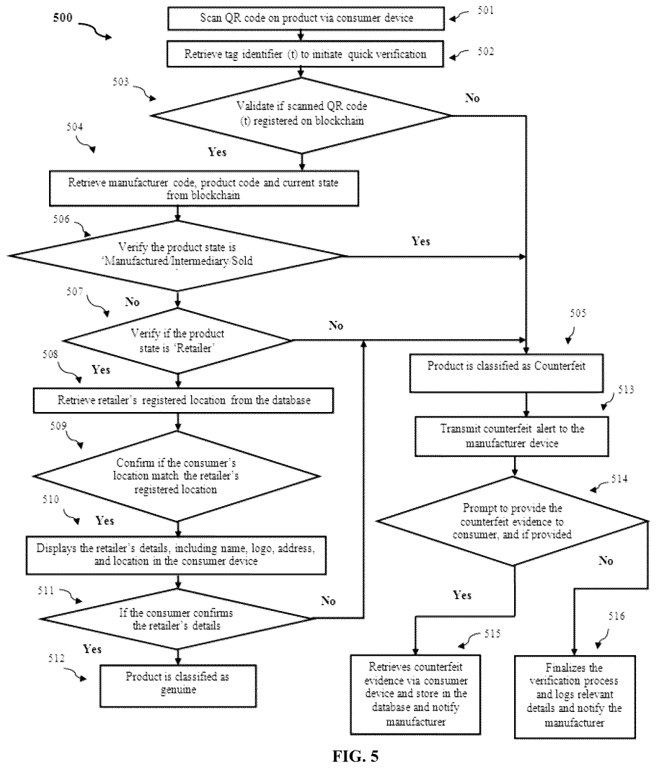

In an embodiment, consumers (105) can use a consumer device (105D) to scan the QR code of purchased products and verify authenticity. The consumer device (105D) can communicate with the authentication and tracking system (101) to cross-check product details with the blockchain smart contract (111C) and centralized DB (109). The specific mechanisms using the consumer device (105D) for verification, authentication, and counterfeit reporting will be further detailed in FIG. 5.

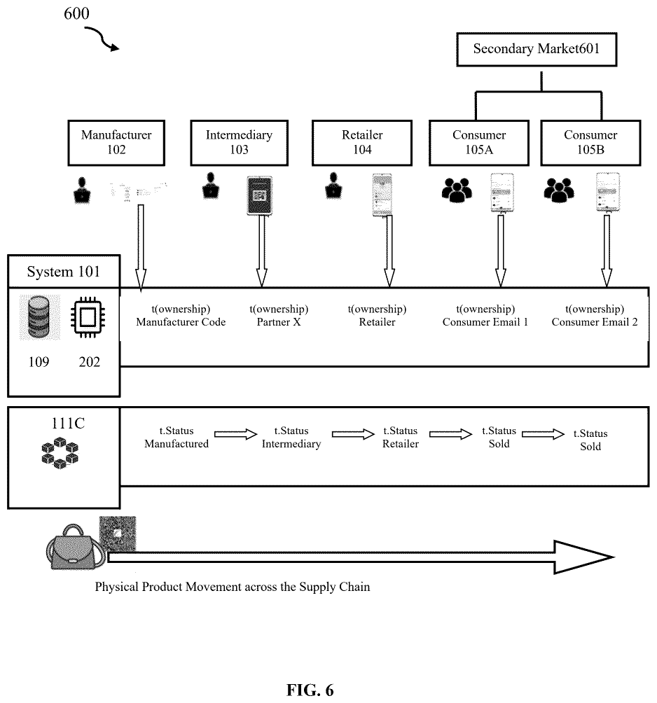

Additionally, the consumer device (105D) can facilitate reporting of counterfeit products, tracking blacklisted locations, managing a product wallet, and engaging in secondary market transactions. Further, ownership transfer and secondary market transactions performed by the consumer (105) will be detailed in FIG. 6.

In an embodiment, the authentication and tracking system (101) can maintain a manufacturer registry stored on the blockchain smart contract (111C), ensuring that only verified manufacturers (102) can input product-related data. The manufacturer registry can include an organization code, manufacturer details, a product business code registry that uniquely identifies product types, a workflow stages registry that tracks product movement, and an API verification route for secure manufacturer verification. Upon successful onboarding, manufacturers (102) can add product and workflow details using authenticated wallet accounts. Privacy-sensitive data, including ownership details linked to individual email addresses, is securely maintained in the centralized DB (109), while non-sensitive product data, such as manufacturer codes, product codes, and product state, is stored in the blockchain (111). The manufacturer registry also maintains details about workflow configurations, registered supply chain partners, and API routes required for verification and authentication.

In an embodiment, the authentication and tracking system (101) can ensure that each stakeholder securely interacts within the framework while preventing unauthorized modifications. The manufacturer device (102D) can enable the generation of unique QR codes for individual products through the QR code generation module (110). Each QR code is encrypted using AES-256 encryption, with a version-controlled private key unique to each manufacturer. The encrypted payload is then hashed using SHA-512 to ensure data integrity and resistance to tampering. The QR code encoding also includes a version number to maintain backward compatibility with prior encrypted versions.

In an embodiment, intermediary devices (103D), retailer devices (104D), and consumer devices (105D) can interact with the authentication and tracking system (101) to update product state, verify ownership, facilitate ownership transfer, and confirm authenticity at different stages of the supply chain. Ownership transitions occurring throughout the supply chain are recorded in the centralized database (109), while only state transitions including intermediaries (e.g., State A, State B), and retailer are also recorded on the blockchain (111) to reflect the product's movement within the supply chain without revealing a public record for intermediary and retailer owner name or code. The blockchain records essential product tracking data, including the tag, product code, manufacturer code, and current state, ensuring traceability without disclosing intermediary and retailer identities. Final consumer ownership transfers-including secondary market transactions—are immutably recorded on the blockchain (111) for authenticity and verification. When a product reaches a retailer (104), its state can be updated accordingly, ensuring proper tracking and verification across the authentication and tracking system (101). The authentication and tracking system (101) can facilitate secure ownership transfer from the manufacturer (102) to intermediaries (103), retailers (104), and ultimately to consumers (105).

In an embodiment, the centralized DB (109) can store product tracking details, manufacturer registry information, ownership records, workflow stage updates, and non-encrypted QR code payloads for verification. The centralized DB (109) can maintain product state updates at different supply chain stages, ensuring proper tracking of manufacturer, intermediary, retailer, and consumer interactions based on status changes. Additionally, the centralized DB (109) can store blacklist records for counterfeit reporting and facilitate API verification routes for external authentication.

In an embodiment, the authentication and tracking system (101) provides a robust counterfeit detection mechanism through a combination of immutable blockchain records, cryptographically secured authentication data, and real-time tracking capabilities. The blockchain smart contract (111C) can serve as a validation layer, allowing consumers (105) and other participants to verify product authenticity directly from the blockchain (111). Additionally, the smart contract enforces predefined workflow rules, preventing unauthorized state modifications or counterfeit insertions into the supply chain.

In an embodiment, the authentication and tracking system (101) can be implemented as a combination of hardware and programming (for example, programmable instructions) to implement one or more functionalities of the processor. In examples described herein, such combinations of hardware and programming can be implemented in several different ways. For example, the programming for the authentication and tracking system (101) can be processor-executable instructions stored on a non-transitory machine-readable storage medium and the hardware can comprise a processing resource (for example, one or more processors), to execute such instructions. In the present examples, the machine-readable storage medium can store instructions that, when executed by the processing resource, implement the authentication and tracking system (101). In such examples the authentication and tracking system (101) may comprise the machine-readable storage medium storing the instructions and the processing resource to execute the instructions, or the machine-readable storage medium may be separate but accessible to the system 101 and the processing resource. In other examples, the authentication and tracking system (101) can be implemented by electronic circuitry.

In an embodiment, FIG. 2 illustrates an exemplary architecture (200) of the authentication and tracking system (101), comprising core components such as a server (201), a processor (202), a memory (203), a centralized database (109), and a blockchain (111). The processor (202), in conjunction with memory (203), executes multiple functional modules, including the onboarding module (205), QR code generation module (110), tag status management module (207), authentication module (208), ownership transfer module (209), and blockchain integration module (210). These modules collectively enable secure product authentication, supply chain tracking, and verification through blockchain and centralized DB (109) operations.

In an embodiment, the onboarding module (205) facilitates the verification of manufacturers (102) via Know Your Business (KYB) checks before granting access to product registration and management functionalities. Upon verification, the manufacturer registry is securely recorded on the blockchain smart contract (111C), ensuring tamperproof storage of essential data such as organization codes, product business codes, and workflow stages. Additionally, API verification routes and secure authentication protocols are maintained in the centralized DB (109) to facilitate controlled manufacturer access.

In an embodiment, the QR code generation module (110) enables manufacturers (102) to generate unique QR codes embedded with a tag ID (t) containing the manufacturer code, product code, and state. Each QR code is encrypted using AES-256 encryption with a version-controlled private key unique to each manufacturer. The encryption key undergoes a scheduled rotation every month to enhance security and prevent brute-force attacks. The unique QR codes facilitate tracking and authentication throughout the supply chain and are printed onto the product packaging for seamless integration.

In an embodiment, the tag status management module (207) allows manufacturers (102) and verified supply chain partners (103, 104) to update product states at various levels, including pallet, carton, and pack. Product state updates are initially recorded in the centralized database (109) for validation before being selectively synchronized with the blockchain (111) based on predefined rules. High-level transitions such as ‘Manufactured,’ ‘Intermediary State’, ‘Retailer,’ and ‘Sold’ are stored immutably on the blockchain, ensuring transparent product tracking.

In an embodiment, the authentication module (208) processes QR code scans to verify product authenticity. Quick verification retrieves basic product state from the blockchain (111), while detailed verification accesses retailer location and other metadata from the centralized DB (109). This module ensures multi-layered validation to prevent counterfeit products from entering the supply chain.

In an embodiment, the ownership transfer module (209) manages product ownership transitions at different supply chain stages. State transitions, including Manufactured, Intermediary (State A, State B), Retailer, and Sold, are immutably recorded on the blockchain (111) to enable quick verification. While intermediary and retailer transfers including identifying information like name, identifiers and code are recorded in the centralized database (109) for internal tracking, their state transitions are also stamped on the blockchain to maintain product authenticity and traceability. All consumer ownership transfers-including both initial purchases and secondary market transactions—are permanently recorded on the blockchain (111). Each consumer is identified by an email address linked to a unique blockchain wallet account . . .

In an embodiment, the blockchain integration module (210) enforces compliance with predefined workflows stored in the blockchain smart contract (111C), ensuring that status modifications are only performed by authorized entities following manufacturer-defined workflow rules, thereby preventing unauthorized transitions.

Each module within the authentication and tracking system (101) is designed to facilitate seamless stakeholder interaction while ensuring the integrity, security, and authenticity of product tracking data. The centralized DB (109) securely stores sensitive product tracking details, and blacklist records for counterfeit detection. Additionally, it maintains workflow configurations, secure API authentication protocols, and intermediary supply chain state updates, while the blockchain (111) guarantees the integrity of key supply chain events such as manufacturer and product registry, final ownership transfers, and product state changes.

In an embodiment, FIG. 3 illustrates an exemplary flow diagram (300) of the system and method for generating a unique QR code imprinted on a product, according to an embodiment of the present disclosure.

The exemplary method(s) are illustrated as a collection of blocks in a logical flow graph representing sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described herein.

At block 301, the processor (300) can be configured to initiate the process of generating a unique QR code for a product using a QR code generation module (110). The processor (202) can receive input data from a manufacturer device (102D) regarding a batch of products, including a manufacturer code, product business ID, and hierarchical packaging identifiers such as palette ID, carton ID, and pack ID. The manufacturer code is automatically retrieved from the manufacturer's wallet account, which is then used to invoke the createTags operation on the blockchain smart contract (111C), ensuring uniqueness and preventing duplicate tag entries. If a prior tag exists with the same tag identifier (t), the smart contract (111C) throws an error, preventing duplicate tag creation.

At block 302, the processor (202) can be configured to generate a unique identifier (UP) by concatenating the manufacturer code, product business ID, palette ID, carton ID, and pack ID. The processor (202) can ensure that UP is unique for each product manufactured within the authentication and tracking system (101).

$$UP = ManufacturerCode + ProductBusinessID + PaletteID + CartonID + PackID$$

At block 303, the processor (202) can be configured to create a payload comprising the unique identifier (UP), a timestamp of generation, and extra data attributes specified by the manufacturer. The extra data attributes are stored in a structured JSON format, allowing flexible metadata storage such as product warranty, batch numbers, and other product-related attributes.

$$Payload = UP + Timestamp + ExtraData ( stored in JSON format )$$

At block 304, the processor (202) can be configured to encode the payload in a JSON format to ensure structured and standardized data representation, facilitating seamless retrieval and verification by the authentication module (208).

At block 305, the processor (202) can be configured to encrypt the JSON-encoded payload using AES-256 encryption. The encryption is performed using a version-controlled private key uniquely assigned to each manufacturer, ensuring cryptographic security and resistance to unauthorized modifications. Additionally, the encryption incorporates a version number, enabling periodic key rotation every month. This versioning mechanism ensures that newly generated QR codes are encrypted with the latest key while maintaining backward compatibility. The encrypted payload can be referred to as EPayload, represented as:

$$EPlayload = Encrypt ( Payload , PrivateKey ( manufacturer , version ) )$$

At block 306, the processor (202) can be configured a SHA-512 hash of the encrypted payload (EPayload). This cryptographic hash ensures data integrity, non-predictability, and prevents unauthorized modifications. Since part of the payload (UP) is always unique, the computed hash is also unique, ensuring a non-repeating QR code structure. The generated hash can be referred to as hash.

$$hash = SHA 512 ( EPayload )$$

At block 307, the processor (202) can be configured to generate a header comprising:
A six-digit version code (YYYYMM),
A two-digit chain identifier,
A one-digit encoding format identifier (indicating whether the code is for a palette, carton, or pack), and
A two-character workflow identifier, defined by the manufacturer, representing the product's workflow stage.

$$header = YYYYMM + ChainID + EncodingFormatID + WorkflowID$$

At block 308, the processor (202) can be configured to concatenate the generated header and hash to create a final unique tag identifier (t), ensuring each QR code is distinct and immutable.

$$t = Header + Hash$$

At block 309, the processor (202) can be configured to invoke the QR code generation module (110) to create a graphical QR code representing the tag identifier (t). The QR code can be generated in a format defined by the manufacturer.

At block 310, the processor (202) can be configured to transmit the generated QR code to a printing module, which can imprint the QR code onto product packaging or product labels. The QR code is printed onto the product based on manufacturer-defined specifications to ensure accessibility for scanning during supply chain verification and consumer authentication.

At block 311, the processor (202) can be configured to execute a blockchain smart contract (111C) operation to store the tag identifier (t) along with the manufacturer code, product business ID, and status (e.g., “Manufactured”). The blockchain smart contract (111C) securely maintains an immutable mapping of the tag identifier (t) to its associated metadata, as follows:

$$t ⇒ [ ManufacturerCode , ProductCode , Status ] ( stored on Blockchain )$$

The manufacturer code is auto-populated based on the manufacturer's wallet account and registry lookup when calling the create Tags function. If a prior tag exists with the same tag identifier (t), the smart contract throws an error, preventing duplicate tag creation. To maintain privacy assurance, sensitive data is deliberately excluded from blockchain storage and is instead securely maintained in the centralized database (109), accessible only to authorized entities.

Additionally, upon manufacturer onboarding or the addition of new products, the Manufacturer Registry is securely stored on the blockchain smart contract (111C). The registry contains non-sensitive metadata that is publicly accessible, while private details (e.g., ownership information) remain in the centralized DB (109). The public Manufacturer Registry such as organization code, product business code registry, workflow stages registry are posted on blockchain smart contract (111C), while the private data such as ownership records including the intermediate, retailer or consumer owner identification information within supply chain details are stored in centralized DB (109).

At block 312, the processor (202) can be configured to store the tag identifier (t), along with the non-encrypted payload and header, in the centralized database (109). This database can be deployed either at the manufacturer's premises or within the SaaS system (101), facilitating internal verification and data retrieval for authorized entities.

$$t , ManufacturerCode ⇒ Playload ( non - encrypted ) + Header ( stored in DB )$$

At any time, the authentication and tracking system (101) can retrieve the state and manufacturer-product workflow details from the blockchain (111) by querying the unique tag identifier (t). Upon scanning a QR code (e.g., t1), a blockchain lookup can retrieve and establish:

Current state (e.g., “Manufactured”, “Intermediary” “Warehouse”, “Sold”).
Associated product (e.g., “Product Business Code X”).
Manufacturer information (e.g., “Manufacturer Y”).

For advanced/detailed verification, further details can be obtained from the API route stored in the Manufacturer Registry. This API requires authentication using an OAuth token, ensuring that only registered users with valid authentication can verify product authenticity. Access to detailed metadata is strictly restricted, as privacy-sensitive information remains securely stored in the centralized database (109) and is inaccessible via the API to unauthorized users.

FIG. 4 illustrates an exemplary flow diagram (400) of the system and method for supply chain tracking and status recording, according to an embodiment of the present disclosure.

At block 401, the processor (202) can be configured to initiate supply chain tracking and state recording by receiving product information from the manufacturer device (102D). The processor (202) can extract details including the manufacturer code, product business ID, palette ID, carton ID, and pack ID. The manufacturer code can be auto-populated based on the manufacturer's wallet account, ensuring that the correct entity is initiating the process. The processor (202) can validate the extracted details to ensure completeness and consistency before proceeding to state recording.

At block 402, the processor (202) can be configured to create an initial record in the centralized database (109), indicating that the product has been manufactured. The processor (202) can execute the createTag function on the blockchain smart contract (111C) to register the tag identifier (t) and associate it with the manufacturer code and product code. The processor (202) can execute a blockchain transaction to record the initial state as ‘Manufactured’ on the blockchain (111), ensuring immutable traceability, while simultaneously storing ownership metadata in the centralized database (109) for secure record-keeping. The processor (202) can ensure that the state recorded on the blockchain and in the centralized database remains synchronized.

At block 403, the processor (202) can be configured to monitor and update the state as the product moves through the supply chain. The processor (202) verifies each state transition against predefined workflow rules enforced by the Manufacturer Registry, ensuring that only authorized entities execute transitions in compliance with manufacturer-defined protocols, thereby preventing unauthorized state modifications. The manufacturer (102) can define custom intermediary states such as warehouse, stockist, state A, or state B and assign partner types responsible for transitions. The processor (202) can validate whether the requested state transition conforms to the manufacturer-defined workflow and whether the requesting entity has appropriate authorization. If the transition request is valid, the processor (202) can update the state in the blockchain smart contract (111C) by stamping the state transition (e.g., State A, State B) without recording intermediary identities, ensuring traceability while maintaining privacy. The ownership transition is recorded in the centralized database (109). The processor (202) enforces that intermediary state transitions, such as warehouse and stockist transfers, are also stamped on the blockchain (111) to indicate product movement, while intermediary names and details remain in the centralized database (109). In contrast, final state transitions, such as ‘Retailer’ or ‘Sold,’ are immutably recorded on the blockchain (111) to ensure the integrity of critical supply chain events.

At block 404, the processor (202) can be configured to authenticate intermediary partners before processing state transitions. The processor (202) can verify the authenticity of API-based requests using authentication credentials linked to the partner's wallet account. The processor (202) enforces manufacturer-defined workflow compliance by verifying that the requested transition aligns with predefined state transitions, ensuring that unauthorized or out-of-sequence modifications are systematically rejected. The processor (202) can update the centralized database (204/109) to reflect ownership transfers between intermediary partners while ensuring that state transitions, including intermediary states (e.g., State A, State B), are also stamped on the blockchain (111) under predefined manufacturer-approved workflows, ensuring compliance with authentication rules and preventing unauthorized modifications.

At block 405, the processor (202) can be configured to validate retailer transfer events before updating the state. The processor (202) can verify the retailer's identity using API-based authentication and check whether the workflow conditions allow the transition to the Retailer state. If validated, the processor (202) can execute a blockchain smart contract (111C) transaction to register the state transition to ‘Retailer’ on the blockchain (111), ensuring immutable traceability. Concurrently, the processor (202) updates the centralized database (109) with ownership details, ensuring that privacy-sensitive information remains accessible only to authorized entities.

At block 406, the processor (202) can be configured to register the final sale of the product to a consumer (105). The processor (202) verifies the retailer's request to initiate an ownership transfer by ensuring that the product is currently in the ‘Retailer’ state. The processor (202) executes a blockchain transaction to transition the product to ‘Sold,’ linking it to the consumer's blockchain wallet. Additionally, the processor records consumer metadata (email and timestamp) in the centralized database (109) to ensure privacy compliance while maintaining verifiable ownership history. The processor (202) ensures that the blockchain record and centralized database entry remain synchronized to prevent unauthorized reselling or fraudulent modifications.

At block 407, the processor (202) can be configured to perform real-time verification of the QR code (t) to determine product authenticity. The processor (202) can retrieve the current state from the blockchain smart contract (111C) and verify its legitimacy. If the retrieved state is ‘Manufactured,’ ‘an intermediary state’, or ‘Sold’ while being scanned in an unauthorized location or by an unverified entity, the processor (202) can classify the product as counterfeit, ensuring immediate fraud detection and supply chain integrity enforcement. If the state is Retailer, the processor (202) can perform additional verification based on the retailer's location before confirming authenticity. The processor (202) ensures that only authenticated products in their expected states are verified, preventing unauthorized reselling, counterfeit insertion, or unauthorized modifications at any supply chain stage.

FIG. 5 illustrates an exemplary flow diagram (500) of the system and method for quick and detailed verification of a product's authenticity and reporting counterfeit, according to an embodiment of the present disclosure.

At block 501, the processor (202) can be configured to receive a verification request when a consumer scans a QR code (t) placed on a product using the consumer device (105D).

At block 502, the consumer device (105D) can extract the tag identifier (t) from the scanned QR code and initiate a quick verification request by communicating with the authentication and tracking system (101).

At block 503, the processor (202) verifies whether the scanned QR code (t) is registered on the blockchain smart contract (111C).

At block 504, the processor while verifying the scanned QR code (t) exists on the blockchain, the processor (202) can proceed with quick verification and retrieves a manufacturer code, a product code, and a state of the scanned tag identifier (t) from the blockchain smart contract (111C), else at block 505, the QR code (t) is not recorded on the blockchain, the processor (202) can classify the product as counterfeit and immediately notify the consumer device (105D) while triggering an automated counterfeit alert to the manufacturer for further review.

At block 506, the processor (202) can be configured to analyze the retrieved state to determine its validity. If the state is “Manufactured (AA)” or “Intermediary (State A), the processor (202) can determine that the product has not yet reached a retailer and classify the product as counterfeit. If the state is “Sold,” the processor (202) can determine that the product has already been purchased and cannot be resold. The processor (202) can return a counterfeit warning to the consumer device (105D) and trigger an alert to the manufacturer.

At block 507, if the state is not ‘Retailer (YZ),’ the processor (202) determines that the product has not yet reached an authorized retail point and may be in an unauthorized intermediary state. The processor (202) classifies the product as counterfeit and notifies the consumer device (105D) that the scanned product is invalid for sale. If the state is “Retailer (YZ),” the processor (202) can determine that the product is eligible for sale and proceed with detailed verification.

At block 508, the processor (202) can be configured to perform detailed verification by requesting latitude and longitude data of a consumer's current location from the consumer device (105D). The processor (202) can retrieve a retailer's organization code and a registered branch latitude and longitude from a centralized database (109). The processor (202) can also retrieve the manufacturer code and payload information from the blockchain smart contract (111C).

At block 509, the processor (202) can compare the consumer's latitude and longitude with the geolocation records of the registered retailer. If the consumer's location falls within an acceptable proximity range of the registered retailer's coordinates, the processor (202) proceeds to a consumer confirmation step. If the verifier's location is outside the predefined range, the processor (202) initiates counterfeit alert processing.

At block 510, the processor (202) can be configured to display retailer details, including a name, a logo, an address, latitude, and longitude, on the consumer device (105D).

At block 511, the processor (202) can prompt the consumer to confirm whether the consumer is physically present at the displayed retailer location.

At block 512, if the consumer confirms physical presence at the displayed retailer location, the processor (202) classifies the product as genuine and displays a verification success message on the consumer device (105D), else at block 505, the consumer denies being at the displayed location, the processor (202) classifies the product as counterfeit and proceeds to counterfeit alert processing.

At block 513, the processor (202) triggers an automated counterfeit alert to the manufacturer, including scanned verifier's latitude and longitude, registered retailer's geolocation data, verifier's confirmation response, and associated QR code details (t), ensuring real-time counterfeit tracking and intervention.

At block 514, the processor (202) can prompt the consumer device (105D) to confirm whether the consumer wants to report the counterfeit product.

At block 515, if the consumer chooses to report the counterfeit product, the processor (202) can proceed to consumer reporting. The processor (202) can provide an option for the consumer to submit evidence of counterfeit suspicion, including photos of the product, videos of packaging, labels, or inconsistencies, and additional comments regarding counterfeit suspicions. If the consumer submits counterfeit evidence, including photos, videos, or additional comments, the processor (202) securely stores the evidence in the centralized database (109) for forensic verification and counterfeit tracking. The processor (202) notifies the manufacturer, enabling further investigation and legal enforcement if required.

At block 516, if the consumer chooses not to report the counterfeit product, the processor (202) can stop further processing and log the counterfeit alert for manufacturer review. The processor (202) finalizes the verification process and logs relevant details, including the scanned QR code identifier (t), verification outcome (genuine or counterfeit), blockchain validation status, verifier's scanned latitude and longitude, registered retailer's latitude and longitude, consumer confirmation response, and any submitted counterfeit evidence, in the centralized database (109). The processor (202) notifies the manufacturer if a counterfeit alert was triggered, ensuring that the manufacturer has access to verification logs for further analysis and counterfeit tracking. The stored logs enable structured record-keeping for supply chain monitoring and facilitate regulatory compliance, fraud investigations, and counterfeit enforcement measures if required.

FIG. 6 illustrates an exemplary system (600) architecture for ownership transfer and secondary market transactions performed by the consumer (105), according to an embodiment of the present disclosure.

The processor (202) can be configured to receive an ownership transfer request when a buyer also known as a consumer (105B) initiates a purchase by scanning a QR code (t) using the consumer device (105D). The consumer device (105D) can extract the tag identifier (t) from the scanned QR code and initiate a request to retrieve ownership records by communicating with the authentication and tracking system (101). The processor (202) first verifies whether the tag identifier (t) exists in the blockchain smart contract (111C) to confirm product authenticity. If the tag identifier (t) is absent from the blockchain (111C), the processor (202) classifies the product as counterfeit, immediately notifies the consumer device (105D), and triggers an automated counterfeit alert to the manufacturer, ensuring real-time fraud prevention and investigation. If the tag identifier (t) is found, the processor (202) retrieves ownership records from the centralized database (109) to proceed with ownership verification.

The processor (202) can be configured to retrieve the manufacturer code, product business code, and product state associated with the scanned tag identifier (t) from the blockchain smart contract (111C). The processor (202) can verify whether the product is eligible for ownership transfer by retrieving the current ownership record from the centralized database (109). If the blockchain smart contract (111C) indicates that the product is flagged as counterfeit or stolen, the processor (202) prevents ownership transfer and notifies the consumer device (105D). The processor (202) logs the restricted transaction attempt in the centralized database (109) for fraud monitoring and manufacturer review. If the product is valid for transfer, the processor (202) can proceed to seller ownership verification.

The processor (202) can be configured to retrieve the seller's ownership record also known as consumer (105A) from the centralized database (109) and verify whether the seller is the registered owner of the product. The processor (202) verifies that the seller's email ID and blockchain wallet address match the records stored in the centralized database (109). If any mismatch is detected, the processor (202) denies the ownership transfer request, notifies both the seller and the consumer device (105D), and records the failed transaction for manufacturer review. If the seller's credentials do not match the stored records, the processor (202) restricts the ownership transfer and logs the unauthorized attempt in the centralized database (109) for fraud analysis. If the seller's credentials are valid, the processor (202) can proceed with the buyer verification process using the authentication and tracking system (101).

The processor (202) can be configured to verify the buyer's credentials before completing the ownership transfer. The buyer's email ID and blockchain wallet address can be retrieved from the consumer device (105D) and verified against the centralized database (109) using the authentication and tracking system (101) to ensure compliance with predefined manufacturer-imposed ownership transfer policies. If the buyer does not meet the eligibility criteria specified by the manufacturer, the processor (202) can restrict ownership transfer and notify the buyer through the consumer device (105D). If the buyer meets the verification criteria, the processor (202) can proceed with executing the ownership transfer.

The processor (202) can be configured to execute the ownership transfer transaction on the blockchain smart contract (111C). The processor (202) can update the tag identifier (t) to associate the buyer's blockchain wallet address as the new owner. The processor (202) records the ownership transfer as a blockchain transaction with a unique identifier, ensuring security and preventing unauthorized modifications. Once the blockchain smart contract (111C) successfully records the ownership transfer, the processor (202) can update the centralized database (109) with the buyer's email ID, ownership timestamp, and compliance records.

The processor (202) can be configured to notify both the seller and the buyer about the successful ownership transfer. The processor (202) can send an email notification to the buyer and the seller using the registered email IDs and update the consumer device (105D) with the new ownership details. The processor (202) can also generate a digital proof of authenticity certificate, which the buyer can access for warranty claims or future resale transactions in the secondary market (601).

The processor (202) can be configured to allow the buyer to initiate a resale transaction in the secondary market (601). The processor (202) can receive a secondary market ownership transfer request from the buyer's consumer device (105D), which includes the tag identifier (t) and the buyer's email ID. The processor (202) can verify whether the seller is the current registered owner by checking the ownership status on the blockchain smart contract (111C) and validating the seller's ownership record in the centralized database (109).

The processor (202) can be configured to execute the secondary market ownership transfer after verifying the credentials of the new buyer. The processor (202) can update the blockchain smart contract (111C) to record the new owner's blockchain wallet address while storing the new buyer's email ID in the centralized database (109). The processor (202) can send an ownership transfer confirmation to both the seller and the new buyer via email.

The processor (202) can be configured to prevent unauthorized ownership transfers by enforcing predefined manufacturer-imposed rules and restrictions. If a product is subject to transfer restrictions due to compliance policies, regional limitations, or regulatory requirements, the processor (202) can block the transaction and notify the seller and buyer. The processor (202) can log failed ownership transfer attempts in the centralized database (109) and flag potential fraudulent activities for further investigation.

The processor (202) can be configured to finalize the ownership transfer process and record ownership history for compliance tracking. The processor (202) can store ownership transfer records, including the tag identifier (t), blockchain transaction history, seller and buyer wallet addresses, and transfer timestamps. The processor (202) ensures that email IDs and compliance records are maintained in the centralized database (109) for future ownership verification, compliance audits, and manufacturer access to transaction logs.

In an embodiment, the authentication and tracking system (101) is designed to ensure that every QR code is unique, counterfeit-proof, and duplication-resistant through a combination of cryptographic encryption, blockchain verification, and predefined workflow enforcement mechanisms. While the QR code generation process has been described in FIG. 3, the present section highlights the system-wide security framework that prevents unauthorized replication or tampering.

The authentication and tracking system (101) ensures that each QR code is unique and unpredictable by leveraging blockchain-based smart contract validation, hierarchical QR code structuring, and version-controlled encryption. The blockchain smart contract (111C) enforces that each tag identifier (t) is uniquely mapped to a product and prevents any re-registration. The hierarchical structure of QR codes, constructed from product-specific identifiers such as ManufacturerCode, ProductBusinessID, PaletteID, CartonID, and PackID, ensures that duplication is inherently prevented at multiple levels of product packaging. Additionally, the encryption process incorporates version-controlled key rotation, which periodically updates cryptographic keys to prevent predictability and brute-force attacks.

The QR code generation is effectively mitigated through multi-layered authentication and real-time blockchain verification. Upon scanning, the authentication module (208) queries the blockchain smart contract (111C) to verify the validity of the tag identifier (t). If the scanned QR code does not match an existing blockchain entry, it is immediately flagged as counterfeit. The manufacturer registry stored in the blockchain smart contract (111C) ensures that only verified manufacturers (102) can generate QR codes, preventing unauthorized entities from creating fraudulent product tags. Further, the authentication system employs a two-stage product verification process, wherein basic product state is retrieved from the blockchain for quick verification, while detailed verification accesses additional historical and ownership data from the centralized database (109). Additionally, the authentication and tracking system (101) maintains a blacklist of reported counterfeit QR codes. If a counterfeit QR code is detected, it is recorded in the blacklist, and subsequent scans trigger fraud alerts, ensuring that counterfeit products do not enter the supply chain.

The authentication and tracking system (101) implements blockchain-based validation, real-time QR code status tracking, and supply chain monitoring to eliminate the possibility of duplicate QR codes. The blockchain smart contract (111C) enforces uniqueness by rejecting any attempt to register a duplicate tag identifier (t). If a previously assigned tag identifier is detected, the blockchain transaction is automatically invalidated, ensuring that duplicate QR codes cannot be created or reused. The system further prevents duplication by maintaining immutable product state transitions recorded on the blockchain (111), ensuring that product movement follows a verified sequence from “Manufactured” to “Intermediary,” “Retailer,” and “Sold.” Any discrepancies in expected product movement or conflicting scans at multiple locations result in the system flagging the QR code as a duplicate. The authentication module (208) cross-verifies each QR scan against blockchain status records and manufacturer logs stored in the centralized database (109). If a single QR code is detected in conflicting states across different locations, it is marked as fraudulent. Additionally, the system records the geolocation and timestamp of each QR code scan, ensuring that product movements follow a logical supply chain progression. If a QR code is scanned in a location inconsistent with its expected supply chain state, the system identifies unauthorized duplication and triggers an alert.

The authentication and tracking system (101) implements a multi-layered security architecture that ensures each QR code remains unique and unpredictable, counterfeit QR codes cannot be registered or validated, and duplicate QR codes are automatically detected and rejected. By combining blockchain enforcement, cryptographic security, and supply chain tracking, the system guarantees end-to-end product authentication and fraud prevention. Additionally, the system ensures that ownership transfers are immutable, counterfeit QR codes cannot be registered, and duplicate tags are systematically detected and flagged.

A main advantage of the present disclosure is that it provides a system and method for identifying counterfeit products using live verification with unique, unpredictable, and tamperproof QR codes that are cryptographically secured and integrated with blockchain technology.

Another main advantage of the present disclosure is that it ensures the generation of unique and non-replicable QR codes for each individual product by encrypting them using AES-256 and SHA-512 hashing, thereby preventing unauthorized duplication and counterfeit attempts.

Still another advantage of the present disclosure is that it enables real-time verification of product authenticity using quick and detailed verification mechanisms, which can be accessed through consumer applications or authorized APIs integrated with the authentication and tracking system (101).

Yet another advantage of the present disclosure is that it maintains tamper-proof product data and ownership records using blockchain's immutable ledger capabilities, ensuring data integrity and traceability across the supply chain, from the manufacturer (102) to consumers (105).

Still another advantage of the present disclosure is that it facilitates secure ownership transfers within the supply chain and in secondary market transactions by linking product ownership to consumer blockchain wallet accounts, ensuring data privacy and authenticity verification.

Yet another advantage of the present disclosure is that it prevents counterfeit products from infiltrating the supply chain by restricting QR code generation and product data updates to only authorized manufacturers and verified supply chain partners.

Still another advantage of the present disclosure is that it ensures a privacy-preserving verification process, allowing consumers and stakeholders to authenticate products without exposing sensitive supply chain or ownership data to unauthorized parties.

Yet another advantage of the present disclosure is that it enables effective counterfeit detection and reporting by allowing consumers and stakeholders to submit evidence of counterfeit activities through their devices, which is securely stored in the centralized database for manufacturer review and legal action.

Still another advantage of the present disclosure is that it supports interoperability with multiple blockchain platforms, including both public and private blockchains, making it scalable and adaptable for different industries requiring authentication and tracking solutions.

Yet another advantage of the present disclosure is that it enhances consumer trust and brand protection by providing a transparent, secure, and easy-to-use product authentication system, ensuring that genuine products can be distinguished from counterfeit ones with minimal effort.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system (100) for identifying counterfeits and secure authentication of products using live verification with unique, privacy-preserving, and tamperproof QR codes integrated with a blockchain (111), the system (100) comprising:
an authentication and tracking system (101) including a server (201), wherein the server comprises:
a processor (112) coupled with a centralized database (109) and a memory (113), the processor being configured to:
generate a unique code for each product, by:
receiving product-related data from a manufacturer device (102D), including a manufacturer identifier, a product identifier, and hierarchical packaging identifiers comprising a palette identifier, a carton identifier, and a pack identifier,
generating a unique identifier (UP) by combining the manufacturer identifier, product identifier, palette identifier, carton identifier, and pack identifier, creating a structured payload by encoding the unique identifier (UP), timestamp, and additional product metadata in a structured format,
encrypting the structured payload using a cryptographic algorithm with a version-controlled private key, wherein the encryption key undergoes periodic rotation,
generating a hash of the encrypted payload, wherein the hash ensures uniqueness and tamper resistance,
constructing a header comprising a version code, a chain identifier, an encoding format identifier, and a workflow identifier,
generating a tag identifier (t) by combining the header and the hash, encoding the tag identifier (t) into a machine-readable code,
transmitting the machine-readable code for application on or association with the corresponding product,
storing the tag identifier (t), manufacturer identifier, product identifier, and immutable product states on a blockchain smart contract (111C), and
storing metadata in the centralized database (109), wherein the metadata comprises verification logs, authentication records, consumer confirmations, and compliance tracking data.
retrieve a product state from the blockchain smart contract (111C) during authentication at a retailer location, by:
receiving a scanned code from a consumer device (105D) and extracting the tag identifier (t),
generating a query command and transmitting the query command to the blockchain smart contract (111C) to retrieve the stored product state, retrieving predefined authentication rules from the centralized DB (109), comparing the retrieved product state with the authentication rules to determine whether the product is in an expected state,
if the retrieved state does not match an expected retailer state, generating a counterfeit alert signal, and
if the retrieved state matches an expected retailer state, executing geolocation-based authentication by retrieving and comparing geolocation data. retrieve and compare geolocation data to confirm consumer presence at an authorized retailer location, by:
retrieving a registered retailer location from the centralized database (109), receiving geolocation data from the consumer device (105D), if permitted, comparing the retrieved geolocation data with the registered retailer location, detecting a mismatch between the retrieved geolocation data and the registered location, and
if the locations do not match, generating a counterfeit alert signal.
generate an authentication result based on consumer confirmation and fraud detection, by:
displaying the retailer's name, logo, address, latitude, and longitude on the consumer device (105D),
prompting the consumer to confirm whether they are physically present at the displayed retailer location,
if the consumer confirms presence, generating an authentication success signal, and
if the consumer denies presence, generating a counterfeit alert signal and initiating counterfeit alert processing by storing the alert log in the centralized database (109), transmitting an alert to the manufacturer device (102D), and restricting further authentication attempts for the scanned tag identifier (t) until verified by the manufacturer,
wherein the system prevents counterfeiting by requiring geolocation-based authentication exclusively at retailer locations before confirming product authenticity, thereby eliminating unauthorized reselling and counterfeit infiltration.

2. The system (100) of claim 1, wherein the processor (112) is further configured to:
prompt the consumer device (105D) to submit a counterfeit report upon detection of an unauthorized product state or a geolocation mismatch;
receive consumer-submitted counterfeit evidence, including images, video recordings, or textual descriptions;
store the counterfeit evidence and verification metadata in the centralized database (109), wherein the verification metadata comprises timestamp, geolocation data, consumer device ID, and scanned tag identifier (t), for fraud analysis; and
log the counterfeit report for forensic verification and regulatory compliance.

3. The system (100) of claim 2, wherein the processor (112) is further configured to:
generate a counterfeit alert trigger signal in response to receiving a counterfeit report;
retrieve product metadata, including the manufacturer code, product code, tag identifier (t), and ownership history;
compile a counterfeit incident report including the product metadata, scanned geolocation, and verification result; and
transmit a counterfeit alert notification to the manufacturer device (102D) for further analysis.

4. The system (100) of claim 1, wherein the processor (112) is further configured to:
receive an ownership transfer request from a consumer device (105D);
retrieve the current ownership record associated with the scanned tag identifier (t) from the centralized database (109) and the blockchain smart contract (111C);
retrieve and compare the seller's and buyer's credentials against predefined ownership transfer policies;
update the blockchain smart contract (111C) to associate the buyer's wallet address with the tag identifier (t); and
store the ownership transfer records in the centralized database (109).

5. The system (100) of claim 4, wherein the processor (112) is further configured to:
receive a secondary market ownership transfer request;
retrieve the current ownership record and manufacturer-imposed transfer restrictions;
retrieve and compare the buyer's credentials against secondary market transfer policies;
update the blockchain smart contract (111C) to associate the buyer's wallet address with the tag identifier (t); and
store the secondary market transfer details in the centralized database (109).

6. A computer-implemented method for identifying counterfeit products and generating a counterfeit alert using blockchain and privacy-preserving, tamperproof QR codes, the method comprising:
receiving a product authentication request from a consumer device (105D), the request comprising a scanned tag identifier (t) extracted from a QR code;
retrieving a product state associated with the tag identifier (t) from a blockchain smart contract (111C);
comparing the retrieved product state with predefined authentication rules to determine whether the product is counterfeit;
retrieving geolocation data from the consumer device (105D) and comparing it with a registered retailer's location;
generating an authentication result based on product state verification and geolocation match; and
generating a counterfeit alert signal if the product is determined to be counterfeit.

7. The method of claim 6, further comprising:
receiving an ownership transfer request from a consumer device (105D), the request comprising a scanned tag identifier (t), a seller's identifier, and a buyer's identifier;
retrieving an ownership record associated with the tag identifier (t) from a blockchain smart contract (111C) and a centralized database (109);
verifying the seller's and buyer's credentials against predefined ownership transfer policies;
updating the blockchain smart contract (111C) to associate the buyer's wallet address with the tag identifier (t); and
storing ownership transfer details in the centralized database (109).

8. The method of claim 7, further comprising:
receiving a secondary market resale request from a consumer device (105D), the request comprising a scanned tag identifier (t), a seller's identifier, and a buyer's identifier;
retrieving a product's resale history and manufacturer-imposed resale restrictions;
verifying the seller's credentials and the buyer's eligibility against predefined resale policies; and
updating the blockchain smart contract (111C) to associate the new buyer's wallet address with the tag identifier (t).
